(19) United States
(12) Patent Application Publication
(10) Pub. No.: US 2014/0300916 A1
(43) Pub. Date: Oct. 9, 2014

(54) PRINT RECOVERY FOR PRINTING SYSTEMS

(71) Applicants: Gerald Donald Boldt, Longmont, CO (US); Gheorghe Bot, Timis (RO); Joseph P. Gaertner, Lafayette, CO (US); Paul Hamilton, Louisville, CO (US); Kumar V. Kadiyala, Boulder, CO (US); Marquis G. Waller, Beverly, OH (US)

(72) Inventors: Gerald Donald Boldt, Longmont, CO (US); Gheorghe Bot, Timis (RO); Joseph P. Gaertner, Lafayette, CO (US); Paul Hamilton, Louisville, CO (US); Kumar V. Kadiyala, Boulder, CO (US); Marquis G. Waller, Beverly, OH (US)

(21) Appl. No.: 13/856,099

(22) Filed: Apr. 3, 2013

(51) Int. Cl. G06F 3/12

(52) U.S. Cl. CPC G06F 3/1261; G06F 3/121; G06F 3/1234
USPC 358/1.14

(57) ABSTRACT

Systems and methods delay a print job from being automatically rescheduled to a backup printer in response to an error at a printer scheduled to print the job. In one embodiment, a control system determines that a printer scheduled to print a job has an error condition, and identifies the error condition at the printer. The control system calculates a time delay based on the error condition before initiating a rescheduling process for the job to a backup printer. The control system initiates the rescheduling process if the time delay has expired, and cancels the rescheduling process if the error condition has ended before the time delay expires.

### FIELD OF THE INVENTION

The invention relates to the field of printing systems, and in particular, to recovering from errors that may arise during the printing process.

### BACKGROUND

Print shops are typically medium or large scale facilities capable of supplying printing services to meet a variety of customer demands. For example, print shops are often used to print documents for mass-mailing (e.g., customer bills, advertisements, etc.). Because print shops engage in printing on a scale that is hard to match, their customer base is usually varied. Print shop clients may therefore include both large institutional clients (e.g., credit card companies and banks), and small clients (e.g., small businesses and churches).

Print shops are generally arranged to print incoming jobs from clients in a way that is economical, yet fast. Thus, print shops often include a number of high-volume printers capable of printing incoming jobs quickly and at high quality. These printers may be managed by operators who can remove paper jams and reload the printers with media. Print shops also typically include post-print devices that are used to process the printed documents of each job (e.g., stackers, staplers, cutters, binders, etc.). Because print shops serve a variety of clients, they are often tasked with printing jobs that have varying printing formats, delivery dates, and media requirements. Print shops therefore often use a centralized print server that receives incoming jobs and allows for jobs to be scheduled for printing at a printer.

In some cases, problems arise during the printing process. For instance, a printer may encounter a paper jam, run out of colorant, run out of media for a job, etc. Often the print server is configured to automatically reschedule jobs from the failed printer to a backup printer if errors occur. This ensures that the jobs continue to print while the error condition at the printer is reviewed by a print operator. However, this may cause unnecessary rescheduling for jobs when the error conditions may be quickly resolved.

### SUMMARY

Embodiments described herein provide a time delay before jobs are automatically rescheduled from a printer that has an error condition to a backup printer. The delay allows time for a print operator to assess the error condition and to possibly resolve the error condition before the job is automatically rescheduled to a backup printer. Thus, minor error conditions that may be readily solved by a print operator do not result in unnecessary rescheduling of jobs between printers. In some cases, rescheduling jobs between printers results in a ping-pong effect as printers go offline and online within a short amount of time, which is undesirable.

One embodiment is a control system for a printing system. The control system is operable to determine that a printer scheduled to print a job has an error condition, to identify the error condition at the printer, and to calculate a time delay based on the error condition before initiating a rescheduling process for the job to a backup printer. The control system is further operable to initiate the rescheduling process if the time delay has expired, and to cancel the rescheduling process if the error condition has ended before the time delay expires.

Another embodiment is a method for scheduling print job. The method comprises determining that a printer scheduled to print a job has an error condition, and to identify the error condition at the printer. The method further comprises calculating a time delay based on the error condition before initiating a rescheduling process for the job to a backup printer. The method further comprises initiating the rescheduling process if the time delay has expired, and to cancel the rescheduling process if the error condition has ended before the time delay expires.

Another embodiment is a non-transitory computer readable medium embodying programmed instructions executable by a processor. The instructions are operable to direct the processor to determine that a printer scheduled to print a job has an error condition, and to identify the error condition at the printer. The instructions further direct the processor to calculate a time delay based on the error condition before initiating a rescheduling process for the job to a backup printer. The instructions further direct the processor to initiate the rescheduling process if the time delay has expired, and to cancel the rescheduling process if the error condition has ended before the time delay has expired.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a printing system in an exemplary embodiment.

FIG. 2 is a flowchart illustrating a method for rescheduling jobs in an exemplary embodiment.

FIG. 3 is a block diagram of a GUI for configuring backup printing in an exemplary embodiment.

FIG. 4 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

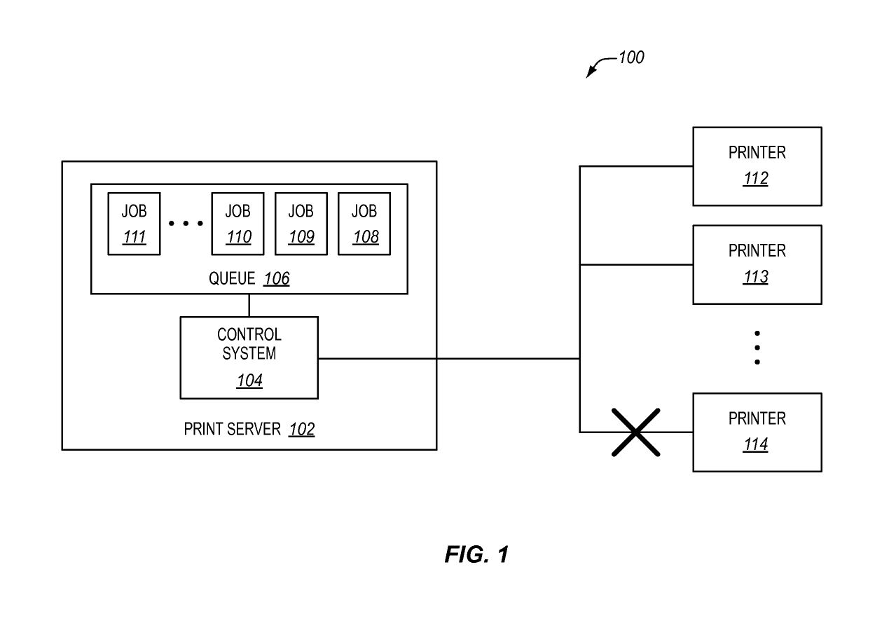

FIG. 1 is a block diagram of a printing system 100 in an exemplary embodiment. In this embodiment, printing system 100 comprises a print server 102 coupled with one or more printers 112-114. Print server 102 implements scheduling of jobs at printers 112-114. Printers 112-114 generally included any printing device that is able to mark a printable media (e.g., paper) with a colorant. Some examples of printers 112-114 include continuous form production printers for high speed/high volume printing.

Print server 102 in this embodiment includes a control system 104 and a print queue 106. Control system 104 communicates with printers 112-114 to determine status information (e.g., error conditions, printing progress for jobs, etc.) for printers 112-114. Control system 104 further manages one or more jobs 108-111 stored by queue 106. Queue 106 generally includes any storage system that is able to spool or store jobs 108-111 that are scheduled for printing at printers 112-114. Some examples of queue 106 include hard disk drives, flash drives, Random Access Memory, etc.

In this embodiment, print server 102 is further configured to enable backup printing for jobs 108-111. Backup printing allows server 102 to respond to error conditions that may arise at printers 112-114 by rescheduling jobs from a failed printer to a backup printer. This ensures that jobs 108-111 continue to print even though a job may be scheduled to print at a printer that is no longer available. For example, if job 111 was originally scheduled to print at printer 114 and printer 114 becomes unavailable, then print server 102 may be configured to automatically reschedule job 111 at one of the other printers 112-113.

In prior systems, automatic rescheduling of jobs occurs regardless of the type of error condition that may arise at a printer or how long it may take an operator to resolve the error condition. For instance, a simple paper jam at a printer may put the printer offline, thereby triggering a rescheduling of jobs for the failed printer to other printers. This can be problematic when jobs are shuffled from one printer to another. For instance, a print operator may be able to clear a paper jam rather quickly, thereby allowing the failed printer to return online for printing jobs. However, when the failed printer returns online, jobs previously scheduled for the printer may have already been rescheduled for other printers. This may then cause jobs to be rescheduled back to the now-online printer, thereby initiating a ping-pong scheduling effect. Or, the print operator may be tasked to manually reschedule jobs back to the printer when it returns online, thereby causing extra work for the print operator.

In this embodiment, control system 104 detects that a printer has failed due to an error condition, and does not automatically initiate a rescheduling process for the jobs from the failed printer to a backup printer right away. Rather, control system 104 implements a time delay that provides the operator time to correct the error. If the error is corrected before the time delay expires, then control system 104 cancels the rescheduling process. However, if the time delay expires before the error condition ends, then control system 104 initiates the rescheduling process.

In some embodiments, the time delay is configured by the print operator. For instance, the print operator may configure print server 102 to implement a time delay of a few minutes for a paper jam error condition at a printer, which would allow the print operator time to clear the jam. In like manner, the print operator may also configure print server 102 to implement a time delay of some tens of minutes for more complicated error conditions (e.g., communication error with a printer) to allow the print operator more time to correct the error condition.

Consider an example whereby a print operator is tasked with printing a job at printing system 100. Jobs 108-111 are received by print server 102 (e.g., from one or more clients or host systems not shown), and are scheduled for printing at printers 112-114. The scheduling of jobs 108-111 may be performed automatically and/or by a print operator. Generally, scheduling of jobs 108-111 is performed at a particular printer based on the type of media for a job, the type of colorant for job, etc. that is available at a printer.

As discussed previously, primary printers may be assigned one or more backup printer to ensure that jobs continue to print if the primary printer fails. For instance, at start of day, a print operator may configure print server 102 to utilize one or more backup printers 112-113 for printer 114 in cases whereby printer 114 becomes unavailable to print jobs.

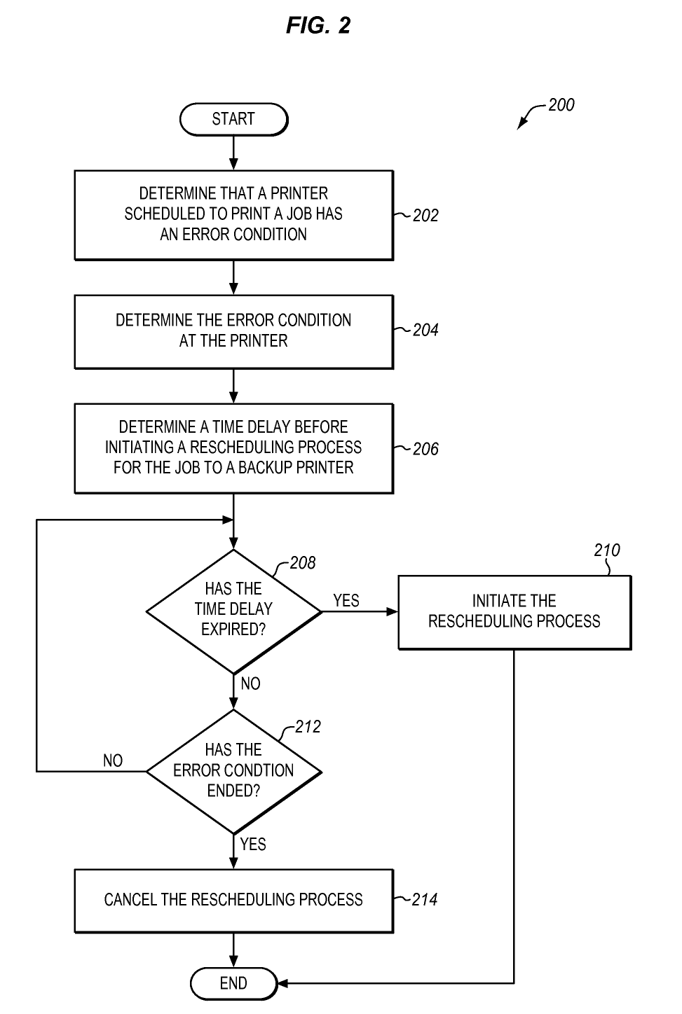

FIG. 2 is a flowchart illustrating a method of scheduling print jobs in an exemplary embodiment. The steps of method 200 will be described with reference to printing system 100 of FIG. 1, but those skilled in the art will appreciate that method 200 may be performed in other systems. The steps of the flowchart(s) described herein are not all inclusive and may include other steps not shown. The steps described herein may also be performed in an alternative order.

In step 202, control system 104 determines that a printer for a job has an error condition (e.g., printer 114, marked with an X in FIG. 1). Some examples of error conditions include paper jams, low or no colorant at the printer, media tray missing, output tray missing, printer access door open, etc. Generally, an error condition will render the printer unavailable for printing jobs. To determine if a printer has an error condition, control system 104 may utilize Simple Network Management Protocol (SNMP) message, Job Message Format (JMF) message, or some other type of communication protocol to monitor the status of printers 112-114.

In step 204, control system 104 determines the error condition at the printer. Control system may query a printer in error to determine the error condition. For instance, control system 104 may query printer 114 utilizing SNMP, JMF, or some other protocol.

In step 206, control system 104 determines a time delay before initiating a rescheduling process for the job to a backup printer. In this embodiment, the time delay is based on the error condition determined by control system 104. In some cases, different error conditions may be configured with different values of time delays. In other cases, the error conditions may be configured with the same value of time delay. Either case is a matter of design choice.

In step 208, control system 104 determines if the time delay has expired. If the time delay has expired, then step 210 is performed to initiate the rescheduling process for the job to the backup printer. If the time delay has not expired, then step 212 is performed.

In step 212, control system 104 determines if the error condition at the printer has ended. For instance, control system 104 may periodically query the failed printer to determine the status of the error condition, may receive input from the print operator regarding the error condition, etc. If the error condition has not ended, then step 208 is performed again to determine if the time delay has expired. However, if the error condition has ended before the time delay expires, then step 214 is performed.

In step 214, control system 104 initiates the rescheduling process to reschedule the jobs to the backup printer. For instance, if printer 112 is assigned as a backup printer for printer 114, then jobs originally scheduled for printer 114 are rescheduled for printer 112. Further, the rescheduled jobs may be pending for a failed printer, may have been currently printing on the failed printer, etc., as a matter of design choice.

### EXAMPLE

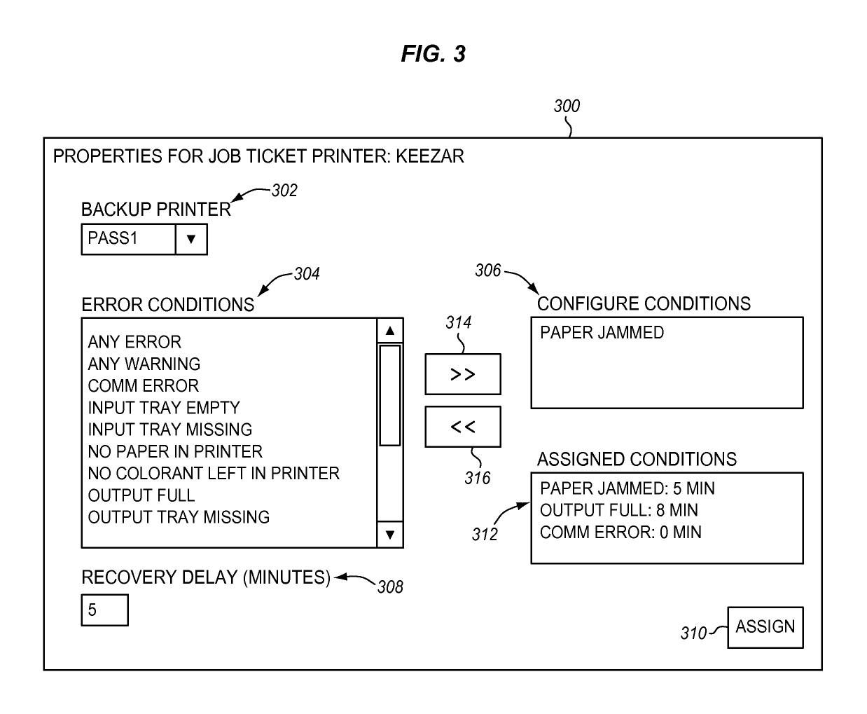

Consider in the following example that a print operator wishes to configure a printer to utilize delays for automatic backup printing. To do so, the print operator may utilize a Graphical User Interface (GUI). FIG. 3 is a block diagram of a GUI 300 for configuring backup printing in an exemplary embodiment. GUI 300 includes a number of user-configurable fields for configuring a printer (keezar in this example) to allow for a delay in rescheduling from the keezar printer to the backup printer 302 (pass1 in this example). A number of error conditions are available for the print operator to configure a time delay for, such as no paper at the printer, output full, output tray missing, no colorant, etc., as illustrated in an error conditions window 304. The print operator can select any number of error conditions using a mouse, keyboard, etc., and move the selected conditions into a configure conditions window 306 using the right arrow button 314. Correspondingly, the print operator may move error conditions out of the configure conditions window 306 using the left arrow button 316.

The print operator may then enter a recovery delay 308 for the error condition(s) that were added to the configure conditions window 306, and assign the recovery delay 308 to the error condition(s) using the assign button 310. In this example, the print operator has assigned a recovery delay of 5 minutes for a paper jammed error condition at the keezar printer, has assigned an 8 minute recovery delay for an output full error condition at the keezer printer, and has assigned a zero minute recovery delay for a cannot contact error condition at the keezer printer.

Based on the settings shown for the keezar printer in FIG. 3, jobs scheduled to print at the keezar printer will be rescheduled to the pass1 printer in response to detecting a particular set of error conditions after the time delay assigned to the error condition expires. For instance, if paper jams at the keezar printer, then the rescheduling of jobs to the pass1 printer is delayed for 5 minutes. This allows time for the print operator to clear the paper jam. However, if contact is lost with the keezar printer, then a time delay of zero indicates that jobs will be rescheduled to the pass1 printer without implementing a delay. This may be desirable in cases when it is unlikely to recover a printer in a reasonable amount of time.

GUI 300 in the example illustrates a number of error conditions that are assigned different recovery times. In this example, a paper jam error condition is assigned a recovery time of 5 minutes while an output full error condition is assigned a recovery time of 8 minutes. In cases whereby multiple error conditions may occur within about the same time, then rescheduling the jobs to the backup printer may be delayed based on the shortest time for the assigned conditions, the longest time for the assigned conditions, etc., as a matter of design choice. For instance, if a paper jam error condition and an output full error condition occurs at about the same time at the keezar printer, then rescheduling the jobs to the pass1 printer may be delayed until after the 8 minute delay expires, which is the longest time delay configured for the error conditions in the assigned conditions window 312. However, in cases where some error conditions are resolved during the wait time while other remain, a recalculation of the time delay may occur based on the remaining error conditions and their respectively assigned recovery delays. For instance, if the output full error condition is resolved during the time delay, then the recovery delay may be recalculated based on the remaining error conditions (e.g., 5 minutes as per the paper jammed condition). This allows for a more flexible approach to implementing the recovery delay in systems that utilize delayed rescheduling of jobs to a backup printer.

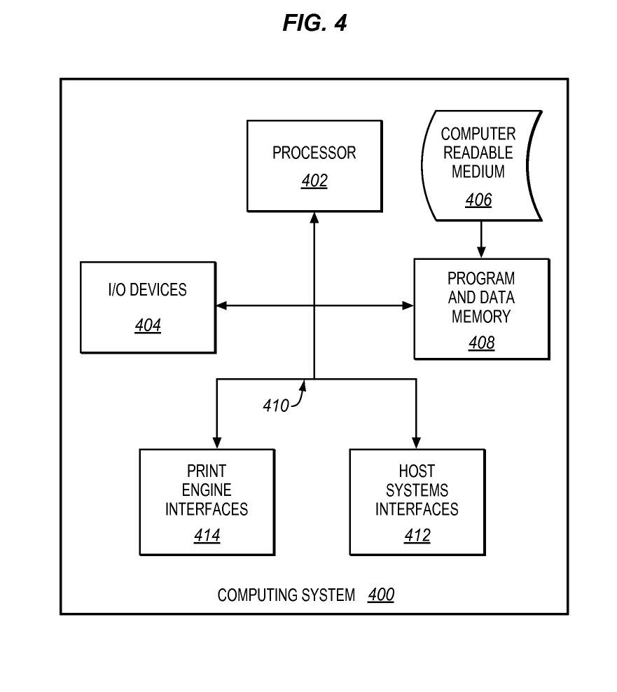

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 4 illustrates a computing system in which a computer readable medium may provide instructions for performing the method of FIG. 2 in an exemplary embodiment.

Furthermore, the invention can take the form of a computer program product accessible from a computer-usable or computer-readable medium 406 providing program code for use by or in connection with a computer or any instruction execution system. For the purposes of this description, a computer-usable or computer readable medium 406 can be any apparatus that can contain, store, communicate, or transport the program for use by or in connection with the instruction execution system, apparatus, or device.

The medium 406 can be an electronic, magnetic, optical, electromagnetic, infrared, or semiconductor system (or apparatus or device) or a propagation medium. Examples of a computer-readable medium 406 include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution.

Input/output or I/O devices 404 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 412, or remote printers or storage devices through intervening private or public networks. Modems, cable modem and Ethernet cards are just a few of the currently available types of network adapters.

Although specific embodiments were described herein, the scope of the invention is not limited to those specific embodiments. The scope of the invention is defined by the following claims and any equivalents thereof.

We claim:

1. A system comprising:
a control system for a printing system, the control system operable to determine that a printer scheduled to print a job has an error condition, to identify the error condition at the printer, and to calculate a time delay based on the error condition before initiating a rescheduling process for the job to a backup printer;
the control system further operable to initiate the rescheduling process if the time delay has expired, and to cancel the rescheduling process if the error condition has ended before the time delay expires.

2. The system of claim 1:
wherein the control system is further operable to identify a plurality of error conditions at the printer, to identify one of the error conditions associated with a shortest time delay, and to calculate the time delay before initiating the rescheduling process based on the shortest time delay.

3. The system of claim 2:
wherein the control system is further operable to identify that the error condition associated with the shortest time delay has ended, and to recalculate the time delay before initiating the rescheduling process based on the error conditions that remain at the printer.

4. The system of claim 1:
wherein the control system is further operable to identify a plurality of error conditions at the printer, to identify one of the error conditions associated with a longest time delay, and to calculate the time delay before initiating the rescheduling process based on the longest time delay.

5. The system of claim 4:
wherein the control system is further operable to determine that the error condition associated with the longest time delay has ended, and to recalculate the time delay before initiating the rescheduling process based on the error conditions that remain at the printer.

6. The system of claim 1:
wherein the control system is further operable to calculate when the job will be rescheduled based on a time the error condition occurred and the time delay before initiating the rescheduling process, and to provide a message to a print operator that indicates when the job will be rescheduled based on the calculation.

7. A method comprising:
determining that a printer scheduled to print a job has an error condition;
identifying the error condition at the printer;
calculating a time delay based on the error condition before initiating a rescheduling process for the job to a backup printer;
initiating the rescheduling process if the time delay has expired; and
canceling the rescheduling process if the error condition has ended before the time delay expires.

8. The method of claim 7:
wherein the step of identifying the error condition further comprises:
identifying a plurality of error conditions at the printer; and
identifying one of the error conditions associated with a shortest time delay; and
wherein the step of calculating the time delay further comprises:
calculating the time delay before initiating the rescheduling process based on the shortest time delay.

9. The method of claim 8:
wherein the step of identifying the error condition further comprises:
identifying that the error condition associated with the shortest time delay has ended; and
wherein the step of calculating the time delay further comprises:
recalculate the time delay before initiating the rescheduling process based on the error conditions that remain at the printer.

10. The method of claim 7:
wherein the step of identifying the error condition further comprises:
identifying a plurality of error conditions at the printer; and
identifying one of the error conditions associated with a longest time delay; and
wherein the step of calculating the time delay further comprises:
calculating the time delay before initiating the rescheduling process based on the longest time delay.

11. The method of claim 10:
wherein the step of identifying the error condition further comprises:
determining that the error condition associated with the longest time delay has ended; and
wherein the step of calculating the time delay further comprises:
recalculating the time delay before initiating the rescheduling process based on the error conditions that remain at the printer.

12. The method of claim 7 wherein the method further comprises:
calculating when the job will be rescheduled based on a time the error condition occurred and the time delay before initiating the rescheduling process; and
providing a message to a print operator that indicates when the job will be rescheduled based on the calculation.

13. A non-transitory computer readable medium embodying programmed instructions executable by a processor, the instructions operable to direct the processor to:
determine that a printer scheduled to print a job has an error condition;
identify the error condition at the printer;
calculate a time delay based on the error condition before initiating a rescheduling process for the job to a backup printer;
initiate the rescheduling process if the time delay has expired; and
cancel the rescheduling process if the error condition has ended before the time delay expires.

14. The medium of claim 13:
wherein instructions to identify the error condition further comprise instructions to:
identify a plurality of error conditions at the printer; and
identify one of the error conditions associated with a shortest time delay; and
wherein instructions to calculate the time delay further comprise instructions to:
calculate the time delay before initiating the rescheduling process based on the shortest time delay.

15. The medium of claim 14:
wherein instructions to identify the error condition further comprise instructions to:
identify that the error condition associated with the shortest time delay has ended; and
wherein instructions to calculate the time delay further comprise instructions to:
recalculate the time delay before initiating the rescheduling process based on the error conditions that remain at the printer.

16. The medium of claim 13:
wherein instructions to identify the error condition further comprise instructions to:
identify a plurality of error conditions at the printer; and
identify one of the error conditions associated with a longest time delay; and
wherein instructions to calculate the time delay further comprise instructions to:
calculate the time delay before initiating the rescheduling process based on the longest time delay.

17. The medium of claim 16:
wherein instructions to identify the error condition further comprise instructions to:
determine that the error condition associated with the longest time delay has ended; and
wherein instructions to calculate the time delay further comprise instructions to:
recalculate the time delay before initiating the rescheduling process based on the error conditions that remain at the printer.

18. The medium of claim 13 wherein the instructions further direct the processor to:
calculate when the job will be rescheduled based on a time the error condition occurred and the time delay before initiating the rescheduling process; and
provide a message to a print operator that indicates when the job will be rescheduled based on the calculation.
